(19) United States
(12) Patent Application Publication
(10) Pub. No.: US 2026/0135413 A1
(43) Pub. Date: May 14, 2026

(54) WIRELESS POWER TRANSFER PROTOCOL FOR AMBIENT POWER DEVICES

(71) Applicant: Cisco Technology, Inc., San Jose, CA (US)

(72) Inventors: Ugo Mario Campiglio, Morges (CH); Domenico Ficara, Essertines-sur-Yverdon (CH); Juan Carlos Zuniga, Montreal (CA); Jerome Henry, Pittsboro, NC (US)

(73) Assignee: Cisco Technology, Inc., San Jose, CA (US)

(21) Appl. No.: 19/278,527

(22) Filed: Jul. 23, 2025

Related U.S. Application Data
(60) Provisional application No. 63/717,920, filed on Nov. 8, 2024.

(51) Int. Cl. H02J 50/80; H02J 50/40

(52) U.S. Cl. CPC H02J 50/80; H02J 50/40

(57) ABSTRACT

A Wireless Power Transfer (WPT) protocol for Ambient Power (AMP) devices may be provided. The WPT protocol can include receiving, from an AMP Station (STA), a frame comprising a device type identifier. One or more charging frame characteristics are determined based on the device type identifier. Next, a charging frame having the one or more charging frame characteristics is transmitted to the AMP STA.

### RELATED APPLICATION

This application claims priority to U.S. Provisional Patent Application No. 63/717,920, titled “WPT Protocol for Onboarding AMP STAs,” filed Nov. 8, 2024, the disclosure of which is hereby incorporated by reference in its entirety.

### TECHNICAL FIELD

The present disclosure relates generally to a Wireless Power Transfer (WPT) protocol for Ambient Power (AMP) devices.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for negotiating Wireless Power Transfer (WPT) protocol requirements in accordance with aspects of the present disclosure.

FIG. 2 is a block diagram of a frame for negotiating WPT protocol requirements in accordance with aspects of the present disclosure.

FIG. 3 is a block diagram of a signal process for negotiating WPT protocol requirements in accordance with aspects of the present disclosure.

FIG. 4 is a flow chart of a method for negotiating WPT protocol requirements in accordance with aspects of the present disclosure.

FIG. 5 is a block diagram of a computing device in accordance with aspects of the present disclosure.

FIG. 6 is a block diagram of a computing device in accordance with aspects of the present disclosure.

### DETAILED DESCRIPTION

### Overview

A Wireless Power Transfer (WPT) protocol for Ambient Power (AMP) devices may be provided. The WPT protocol can include receiving, from an AMP Station (STA), a frame comprising a device type identifier. One or more charging frame characteristics are determined based on the device type identifier. Next, a charging frame having the one or more charging frame characteristics is transmitted to the AMP STA.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Ambient Power (AMP) Stations (STAs) can be of various types with varying operational requirements. AMP STAs operate to harvest ambient power and enable low power and/or low energy storage operation (e.g., battery-free), such as for Internet of Things (IoT) applications in example embodiments. An AMP device can receive or otherwise harvest electrical energy via charging frames (e.g., RF signals) transmitted by an energizing device, such as an Access Point (AP) or energizer, either to charge a power source or perform operations (e.g., when the AMP device is a passive device).

Transmission of charging frames can have various characteristics for supplying a desired periodic supply of energy to an AMP device, including the frequency the charging frames are transmitted and a duration of the charging frames for example. Thus, an AP can generate and transmit charging frames to AMP STAs at adjustable intervals and with adjustable amounts of energy to accommodate the operational requirements of the AMP STAs.

WPT (Wireless Power Transfer) protocols are directed to the transmission of electrical energy from an energizing device to an AMP device. WPT protocol standards for AMP devices are in development (e.g., by working groups of the Institute of Electrical and Electronics Engineers (IEEE)). Because power requirements vary for AMP devices however, AMP STAs require a process for indicating their respective power requirements to the energizing device. The WPT protocol should therefore allow an AMP STA to negotiate or otherwise indicate its power requirements while optimizing the charging frame frequency and duration to satisfy the AMP STAs the energizing device needs to energize.

To negotiate power requirements, an AMP STA can initially inform an AP about its power requirements at or after association and subsequently send feedback after receiving energizing frames to adjust the charging frames for meeting the power requirements. However, the frames the AMP STA uses for negotiating power requirements have a limited length and may need to additional include other information. The number of bits the AMP STA uses to negotiate power requirements should be low enough to adhere to the frame size limitations. Thus, AMP STAs are configured to utilize techniques for communicating power requirements using a limited amount of bits, such as sending a device type identifier, feedback, operating mode information, and/or the like.

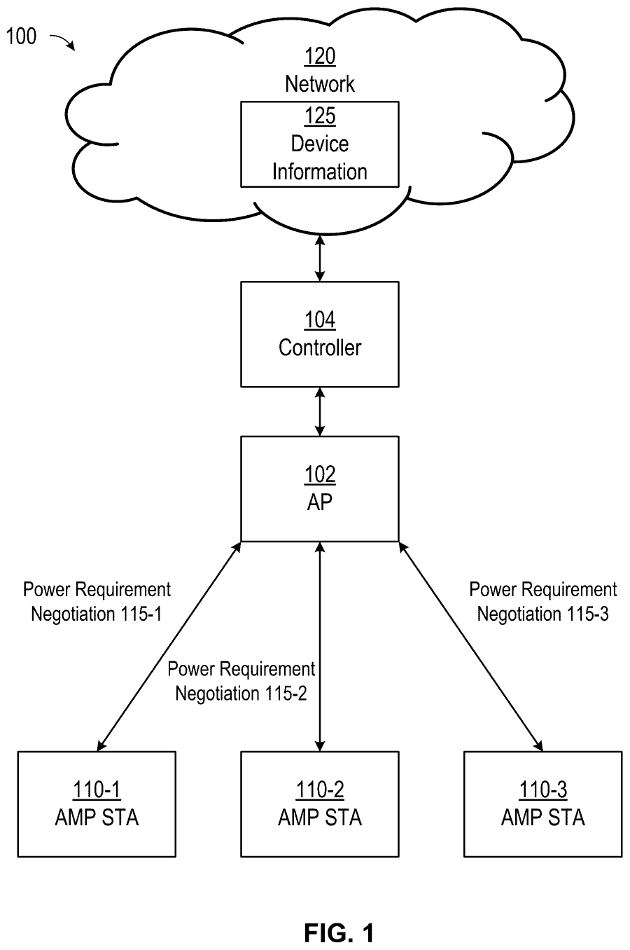

FIG. 1 is a block diagram of an operating environment 100 for negotiating WPT protocol requirements. The operating environment 100 includes an AP 102, a controller 104, AMP STAs 110 (e.g., the first AMP STA 110-1, the second AMP STA 110-2, and the third AMP STA 110-3), and a network 120.

The AP 102 is configured to communicate with and/or enable devices such as the AMP STAs 110 to wirelessly connect to devices of the network 120. The AP 102 is also configured to operate as an energizing device for the AMP STAs 110, including transmitting charging frames having charging frame characteristics to energize each AMP STA 110 for its operation. The controller 104 is a network controller, such as a Wireless Local Area Network (WLAN) controller, configured to manage and control the AP 102, the AMP STAs 110, and/or other network devices to allow wireless devices to connect to and utilize the network 120. The AP 102 and/or the controller 104 can include router components or connect to an external router for routing traffic and otherwise managing the operation of the WLAN. In certain embodiments, the AP 102 acts as a controller and the controller 104 is not present in the operating environment 100. For example, the AP 102 can include components to act as a WLAN controller.

The network 120 is a set of devices that facilitate communication between senders and destinations, such as by implementing communication protocols. Example networks 120 include local area networks, wide area networks, intranets, or the Internet. In certain embodiments, the network 120 includes a device information system 125 and/or other systems for WPT protocol charging negotiation. The device information system 125 can store device characteristics for multiple device types, and the AP 102 can use the device characteristics to determine charging frame characteristics for a corresponding device type. The device information system 125 can be any combination of components, such as one or more servers storing the device characteristics.

The AMP STAs 110 are devices that can transmit and receive data using ambient power, such as energy harvested from charging frames the AP 102 transmits. Each AMP STA 110 has device characteristic that influence its operational power requirements. The device characteristics can include physical characteristics, operating modes, transmission characteristics, charging characteristics, identification characteristics, and/or the like.

For the AP 102 to determine charging frame characteristics for each AMP STA 110 (e.g., to determine the frequency of transmission and duration of charging frames), the AMP STAs 110 and the AP 102 are configured to perform a power requirement negotiation process 115. In certain embodiments, the AMP STAs 110 perform individual power requirement negotiation processes 115 to negotiate their specific power requirements, with the first AMP STA 110-1 performing a first power requirement negotiation process 115-1, the second AMP STA 110-2 performing a second power requirement negotiation process 115-2, and the third AMP STA 110-3 performing a third power requirement negotiation process 115-3. Thus, each AMP STA 110 can indicate its power requirements, and the AP 102 can transmit charging frames with charging frame characteristics tailored to the power requirements of each AMP STA 110.

During the power requirement negotiation process 115, the AMP STAs 110 are configured to indicate the device characteristics to the AP 102. In certain embodiments, the AMP STAs 110 initially share the device characteristics at the time of discovery and/or association with the AP 102 (e.g., via a probe request frame, via an association request frame, etc.). Additionally, the AMP STAs 110 can share the device characteristics, request a change in charging frame transmission, and/or send feedback about transmitted charging frames after initially sharing the device characteristics, such as periodically (e.g., at predetermined time intervals), after switching operating modes, after receiving a charging frame, and so on.

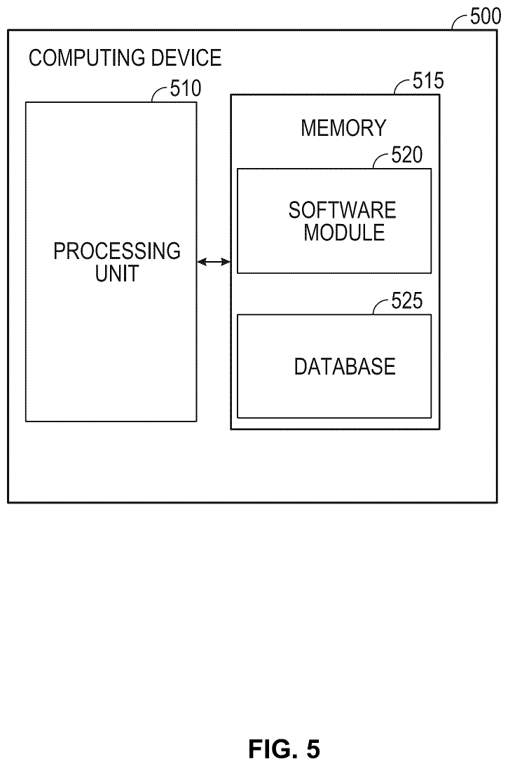

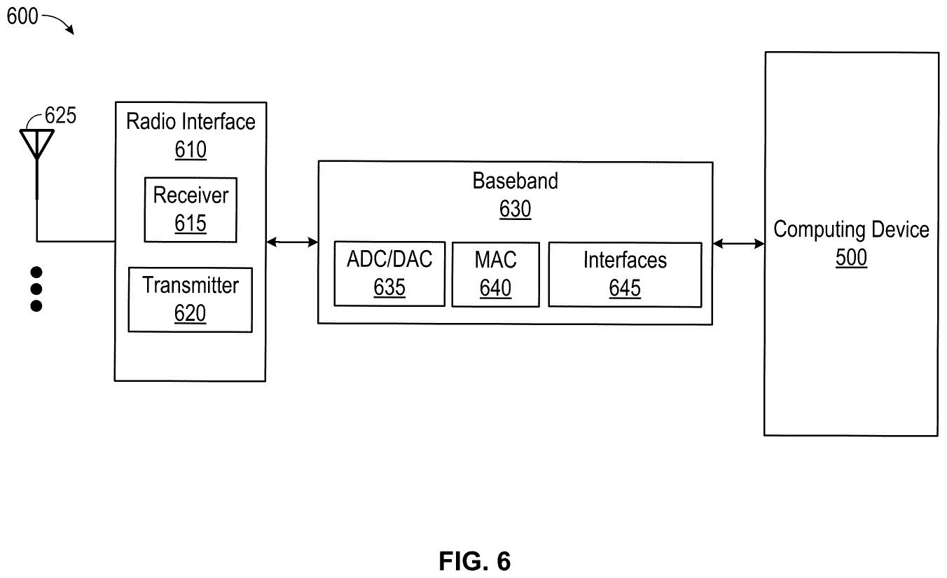

The elements described above of the operating environment 100 (e.g., the AP 102, the controller 104, the AMP STAs 110, the device information system 125, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

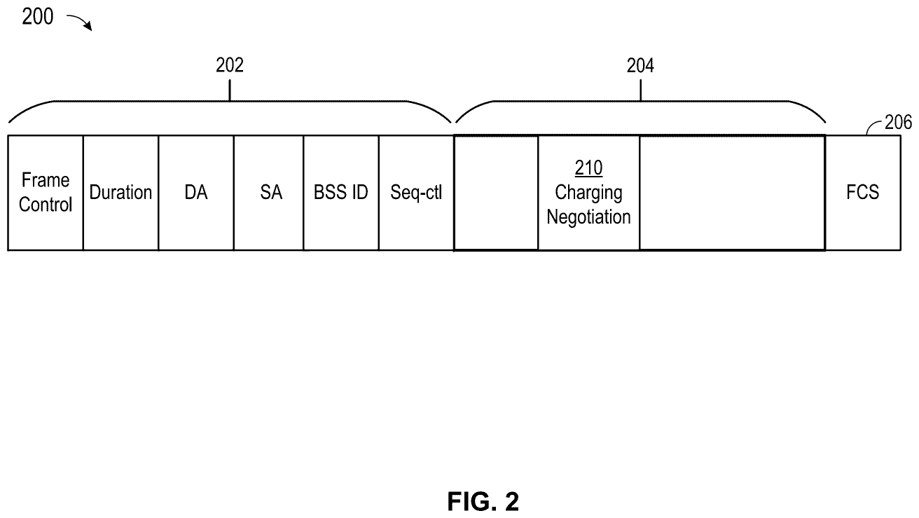

FIG. 2 is a block diagram of a frame 200 for negotiating WPT protocol requirements in accordance with aspects of the present disclosure. The frame 200 can be any frame the AMP STAs 110 use for communicating using IEEE 802.11 protocols, including association request frames, probe request frames, action frames, and the like. The frame 200 comprises a header 202, a body 204, and a frame control sequence 206 in certain embodiments. The body 204 includes a power negotiation field 210. In some embodiments, the power negotiation field 210 is in the header 202.

Frames 200 the AMP STAs 110 use to indicate power requirements and otherwise perform the power requirement negotiation process 115 have a limited length, such as two hundred bits in example implementations. The bits the AMP STAs 110 can use for the power requirement negotiation process 115 are therefore limited and may need to be minimized so a frame can be used for additional purposes. To reduce the amount of bits used for initially indicating power requirements, the power negotiation field 210 can comprise a device type identifier indicating a device type of the AMP STA 110 transmitting the frame 200. In embodiments, the AMP STAs 110 are assigned a device type identifier by an external organization (e.g., Internet Assigned Numbers Authority (IANA), IEEE, Wi-Fi Alliance) or by the manufacturer. The device type identifier can be a unique number, a unique string of characters and/or numbers, an identifier with an Organizationally Unique Identifier (OUI)-extended identifier format, a short Uniform Resource Locator (URL), a compressed URL, or the like for indicating the device type. In example implementation, the device type identifier is four bytes in length or shorter.

The AP 102 can access a device characteristics, such as a device type profile, corresponding to a device type identifier received from an AMP STA 110. For example, the AP 102 can access device characteristics by communicating with the device information system 125. The device information system 125 can store device characteristics for the device types, and the AP 102 can use the device characteristics to determine charging frame characteristics for a corresponding device type. In example implementations, manufacturers of the AMP STAs 110 make the device characteristics available, such as via the device information system 125.

The device characteristics for each device type can include the corresponding device type identifier, manufacturer information (e.g., manufacturer name), a device description, operating modes information, energy capacity, energy requirements, feedback information, and/or the like.

The manufacturer information and device description are informative strings in embodiments. The device description can include a description of what the device does, such as operating as a temperature sensor, a light sensor, and so on. The device can also include URL to a product sheet in example implementations.

The energy capacity information indicates the energy the AMP STA 110 can store. For example, the energy capacity information can indicate zero energy when the AMP STA 110 is a passive device or indicate the capacity of any batteries and/or or capacitors of the AMP STA 110.

The feedback information indicates the feedback the AMP STA 110 will send to the AP 102. For example, feedback unit information indicates the measurement unit the AMP STA 110 will use to indicate any amount of energy harvested after energizing events. In certain embodiments, an AMP STA 110 will provide feedback in the form of a percentage indicate percentage of the device's battery and/or capacitor capacity. In other embodiments, the feedback is the percentage of energy required to perform actions in one of its operating modes (e.g., current operating mode). In further embodiments, the feedback unit is time (e.g., time until the AMP STA 110 requires another charging frame), a requested change in the charging frames (e.g., adjust frequency of transmission, adjust charging frame duration), or the like. The feedback unit therefore allows flexibility for the AMP STAs 110 to indicate retrieved energy with respect to different values.

The operating modes information can include information on one or more modes of the AMP STA 110 including energy requirements for each operating mode, an operating modes vector, and/or the like. The operating modes information can include idle mode information indicating the energy required to maintain stateful operation without performing any other operation. The operating modes information can also include an operation schedule indicating when the AMP STA 110 will operate according to the one or more modes.

An operating modes vector is a list of operating modes of the device. The operating modes vector enables each AMP STA 110 to support up to N operating modes, for example eight modes in certain embodiments. The operating mode 0 may be reserved for the idle mode and represents the device energy requirements for having enough energy to maintain its minimum vital support (e.g., no transmissions, no sensor reading) and be able to maintain its status, keep its memory powered, and resume activities when scheduled.

The other modes can vary for the AMP STAs 110. In some embodiments, the modes for an AMP STA 110 are defined by the manufacturer and vary depending on the device type. One mode for example could define the activity to complete a sensor measurement, another mode could be the activity to respond to an RF-read transaction. Each operating mode of the operating modes vector can include an identifier (e.g., 0-7), a name, a description, a required energy amount, a default scheduled frequency, and/or the like. The name and description may be strings that can be used for identifying actions supported by the device. The required energy amount is the energy required by the device to perform the operation of that mode. The default frequency indicates how often the device expects entering such a mode. For example, a temperature sensor may expect reading and recording the temperature every hour and expects to be read (i.e., transmit the temperature data to the AP 102 or another device) every six hours. For the reserved operating mode 0, the scheduled frequency can represent the minimum charging interval for the device to be able to remain sufficiently charged, and the required energy is the power consumption in between two scheduled frequency intervals.

In certain embodiments, an AMP STA 110 can operate in an opportunistic mode and not charging frames. For example, the first AMP STA 110-1 can operate in the opportunistic mode. The first AMP STA 110-1 can benefit from charging frames transmitted by the AP 102 to other AMP STAs 110 (e.g., the second AMP STA 110-2 or the third AMP STA 110-3) for operation. When the first AMP STA 110-1 determines to request tailored charging frames, the first AMP STA 110-1 can send the device type identifier to the AP 102. The AP 102 can then look up the corresponding device characteristics (e.g. via out of band communications with the device information system 125).

If an AMP STA 110 is configured with a different schedule than the default one for some of the operating modes, it can, at association or at a later time, inform the AP 102 by indicating the operating mode identifier and the new schedule in a dedicated operating mode schedule element. In some embodiments, the operating mode schedule element would contain an identifier for the element, the operating mode identifier, and the new schedule. The new scheduling can be for example encoded in hours, minutes, and seconds. In example implementations, the operating mode schedule element requires only seventeen bits to indicate the new schedule (e.g., five bits for the hours, six bits for the minutes, six bits for the seconds), supporting up to a thirty-one hours, fifty-nine minutes, fifty-nine seconds interval.

As described above, the AMP STA 110 can send feedback to the AP 102 after receiving a charging frame. The feedback can be expressed in the unit specified by the device characteristics. Additionally, the AMP STA 110 can also inform the AP 102 about the charge level of its batteries and/or capacitors (e.g., expressed as percentage of the maximum capacity).

The AP 102 can use the device characteristics and feedback information to schedule charging frames. For example, the AP 102 determines the schedule of operating modes of the AMP STAs 110, the power requirements of each operating mode, the energy received by the AMP STAs 110 compared to the energy sent by the AP 102 in a charging frame or in a charging frame cycle, the charge level of the batteries and/or capacitors of the AMP STAs 110, and/or the like. The AP 102 determines charging frame characteristics for each AMP STA 110, including a frequency to transmit charging frames and a duration of the charging frames for example. The AP 102 may determine the charging frame characteristics to optimally provide sufficient energy with the minimum airtime used for charging frames to reduce or otherwise manage network congestion.

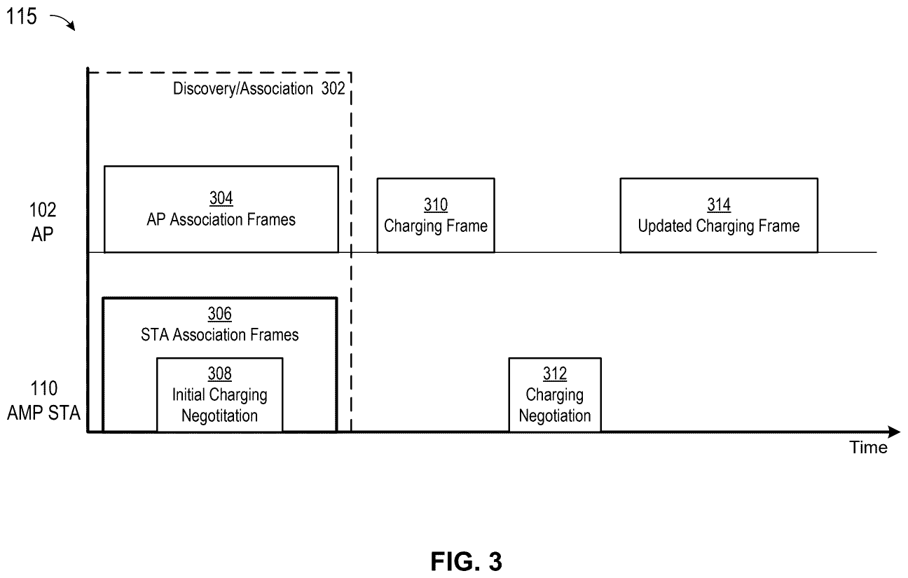

FIG. 3 is a block diagram of an example power requirement negotiation 115. The power requirement negotiation 115 can begin during the discovery and/or association process 302 between the AP 102 and an AMP STA 110. During the discovery and/or association process 302, the AP 102 can send AP association frames 304 to the AMP STA 110 (e.g., probe responses, association responses, etc.). The AMP STA 110 can send STA association frames 306 to the AP 102 (e.g., probe requests, association requests, etc.) One of the STA association frames 306 can also be an initial charging negotiation frame 308 comprising the device type identifier of the AMP STA 110. Thus, the AP 102 receives the device type identifier. In other embodiments, the AMP STA 110 sends the initial charging negotiation frame 308 after association.

The AP 102 can send a charging frame 310 based on the device characteristics determined using the device type identifier in the initial charging negotiation frame 308. For example, the AP 102 receives the device characteristics from the device information system 125. The AMP STA 110 can send another charging negotiation frame 312 in response to the charging frame 310. The charging negotiation frame 312 can include feedback such as a charge level, a request to adjust charging frame characteristics, a schedule update, and/or the like. The AP 102 can send an updated charging frame 314 based on the charging negotiation frame 312.

In some embodiments, an AMP STA 110 may not send an initial charging negotiation frame 308 and instead only send feedback, such as via the charging negotiation frame 312, after receiving a charging frame 310. For example, the AP 102 can use default characteristics for sending the charging frame 310 and then can use the feedback to determine how to adjust characteristics for the updated charging frame 314. Thus, the AP 102 can adjust charging frames without a device identifier in certain embodiments.

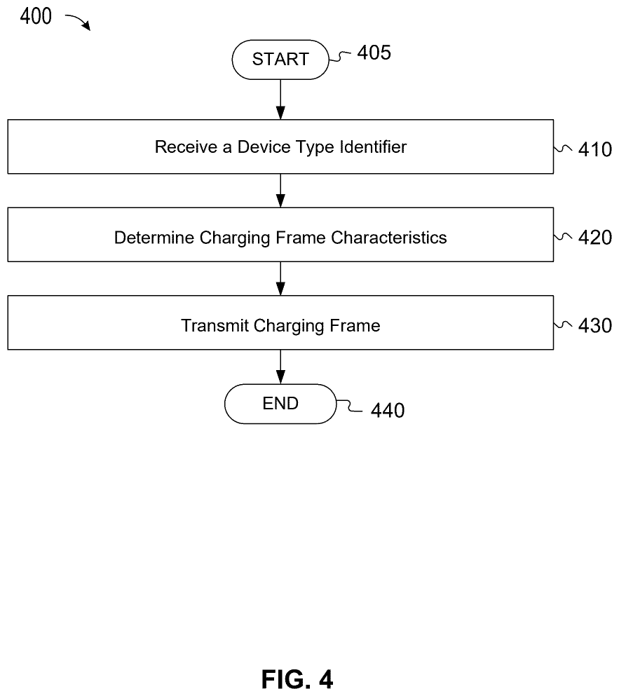

FIG. 4 is a flow chart of a method 400 for negotiating WPT protocol requirements. The method 400 can begin at starting block 405 and proceed to operation 410. In operation 410, a frame comprising a device type identifier is received from an AMP STA 110. For example, the AP 102 receives a frame 200 comprising the device type identifier corresponding to the device type of the AMP STA 110.

In operation 420, one or more charging frame characteristics based on the device type identifier. For example, the AP 102 determines a schedule (e.g., frequency) to transmit charging frames and a duration of the charging frames to supply a determined amount of energy for charging the AMP STA 110 for its current operation. The one or more charging frame characteristics comprise a frequency of transmission and a duration in example implementations.

Determining the one or more charging frame characteristics can include determining one or more device characteristics of the AMP STA based on the device type identifier and determining the one or more charging frame characteristics based on the one or more device characteristics. The AP 102 can determine the device characteristics by communicating with the device information system 125 in example implementations. The one or more device characteristics can comprise manufacturer information, a device description, operating modes information, an energy capacity, energy requirements, feedback information, and/or the like.

In operation 430, a charging frame having the one or more charging frame characteristics is sent to the AMP STA. For example, the AP 102 transmits a charging frame having the charging frame characteristics for the AMP STA 110 to harvest energy.

The method 400 can further comprise determining the AMP STA 110 is changing to a new operating mode (e.g., based on a schedule, based on feedback, based on a schedule change), adjusting the one or more charging frame characteristics based on the new operating mode, and transmitting a new charging frame having the one or more adjusted charging frame characteristics to the AMP STA 110. In certain embodiments, the method 400 further comprises receiving feedback from the AMP STA 110, adjusting the one or more charging frame characteristics based on the feedback, and transmitting a new charging frame having the one or more adjusted charging frame characteristics to the AMP STA 110.

In certain embodiments, the method 400 further comprises determining one or more device characteristics of the AMP STA 110 based on the device type identifier and determining the one or more charging frame characteristics based on the one or more device characteristics, wherein the one or more device characteristics comprises an operating modes vector comprising operating mode information for one or more operating modes. The method 400 can conclude at ending block 440.

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for WPT protocol negotiations with respect to FIGS. 1-4. Computing device 500, for example, may provide an operating environment for the AP 102, the controller 104, the AMP STAs 110, the device information system 125, and the like. The AP 102, the controller 104, the AMP STAs 110, the device information system 125, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

FIG. 6 illustrates an implementation of a communications device 600 that may implement one or more of the AP 102, the controller 104, the AMP STAs 110, the device information system 125, etc., of FIGS. 1-4. In various implementations, the communications device 600 may comprise a logic circuit. The logic circuit may include physical circuits to perform operations described for one or more of the AP 102, the controller 104, the AMP STAs 110, the device information system 125, etc., of FIGS. 1-4, for example. As shown in FIG. 6, the communications device 600 may include one or more of, but is not limited to, a radio interface 610, baseband circuitry 630, and/or the computing device 500.

The communications device 600 may implement some or all of the structures and/or operations for the AP 102, the controller 104, the AMP STAs 110, the device information system 125, etc., of FIGS. 1-4, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHY processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving, from an Ambient Power (AMP) Station (STA), a frame comprising a device type identifier;
determining one or more charging frame characteristics based on the device type identifier; and
transmitting a charging frame having the one or more charging frame characteristics to the AMP STA.

2. The method of claim 1, wherein determining the one or more charging frame characteristics comprises:
determining one or more device characteristics of the AMP STA based on the device type identifier; and
determining the one or more charging frame characteristics based on the one or more device characteristics.

3. The method of claim 2, wherein the one or more device characteristics comprise any one of (i) manufacturer information, (ii) a device description, (iii) operating modes information, (iv) an energy capacity, (v) energy requirements, (vi) feedback information, or (vii) any combination of (i)-(vi).

4. The method of claim 1, wherein the one or more charging frame characteristics comprise a frequency of transmission and a duration.

5. The method of claim 1, further comprising:
determining the AMP STA is changing to a new operating mode;
adjusting the one or more charging frame characteristics based on the new operating mode; and
transmitting a new charging frame having the one or more adjusted charging frame characteristics to the AMP STA.

6. The method of claim 1, further comprising:
receiving feedback from the AMP STA;
adjusting the one or more charging frame characteristics based on the feedback; and
transmitting a new charging frame having the one or more adjusted charging frame characteristics to the AMP STA.

7. The method of claim 1, further comprising:
determining one or more device characteristics of the AMP STA based on the device type identifier; and
determining the one or more charging frame characteristics based on the one or more device characteristics, wherein the one or more device characteristics comprises an operating modes vector comprising operating mode information for one or more operating modes.

8. A system comprising:
a memory storage; and
a processing unit coupled to the memory storage, wherein the processing unit is operative to:
receive, from an Ambient Power (AMP) Station (STA), a frame comprising a device type identifier;
determine one or more charging frame characteristics based on the device type identifier; and
transmit a charging frame having the one or more charging frame characteristics to the AMP STA.

9. The system of claim 8, wherein to determine the one or more charging frame characteristics comprises to:
determine one or more device characteristics of the AMP STA based on the device type identifier; and
determine the one or more charging frame characteristics based on the one or more device characteristics.

10. The system of claim 9, wherein the one or more device characteristics comprise any one of (i) manufacturer information, (ii) a device description, (iii) operating modes information, (iv) an energy capacity, (v) energy requirements, (vi) feedback information, or (vii) any combination of (i)-(vi).

11. The system of claim 8, wherein the one or more charging frame characteristics comprise a frequency of transmission and a duration.

12. The system of claim 8, the processing unit being further operative to:
determine the AMP STA is changing to a new operating mode;
adjust the one or more charging frame characteristics based on the new operating mode; and
transmit a new charging frame having the one or more adjusted charging frame characteristics to the AMP STA.

13. The system of claim 8, the processing unit being further operative to:
receive feedback from the AMP STA;
adjust the one or more charging frame characteristics based on the feedback; and
transmit a new charging frame having the one or more adjusted charging frame characteristics to the AMP STA.

14. The system of claim 8, the processing unit being further operative to:
determine one or more device characteristics of the AMP STA based on the device type identifier; and
determine the one or more charging frame characteristics based on the one or more device characteristics, wherein the one or more device characteristics comprises an operating modes vector comprising operating mode information for one or more operating modes.

15. A non-transitory computer-readable medium that stores a set of instructions which when executed perform a method executed by the set of instructions comprising:
receiving, from an Ambient Power (AMP) Station (STA), a frame comprising a device type identifier;
determining one or more charging frame characteristics based on the device type identifier; and
transmitting a charging frame having the one or more charging frame characteristics to the AMP STA.

16. The non-transitory computer-readable medium of claim 15, wherein determining the one or more charging frame characteristics comprises:
determining one or more device characteristics of the AMP STA based on the device type identifier; and
determining the one or more charging frame characteristics based on the one or more device characteristics.

17. The non-transitory computer-readable medium of claim 16, wherein the one or more device characteristics comprise any one of (i) manufacturer information, (ii) a device description, (iii) operating modes information, (iv) an energy capacity, (v) energy requirements, (vi) feedback information, or (vii) any combination of (i)-(vi).

18. The non-transitory computer-readable medium of claim 15, wherein the one or more charging frame characteristics comprise a frequency of transmission and a duration.

19. The non-transitory computer-readable medium of claim 15, the method executed by the set of instructions further comprising:
determining the AMP STA is changing to a new operating mode;
adjusting the one or more charging frame characteristics based on the new operating mode; and
transmitting a new charging frame having the one or more adjusted charging frame characteristics to the AMP STA.

20. The non-transitory computer-readable medium of claim 15, the method executed by the set of instructions further comprising:
receiving feedback from the AMP STA;
adjusting the one or more charging frame characteristics based on the feedback; and
transmitting a new charging frame having the one or more adjusted charging frame characteristics to the AMP STA.
